(19) United States
(12) Patent Application Publication
(10) Pub. No.: US 2009/0138441 A1
(43) Pub. Date: May 28, 2009

(54) Additional Content Information

(75) Inventors: Andrew Valentine, Hampshire (GB); David Poupon, Conflans Sainte Honorine (FR); Franck Bachet, Rue du Hamel Breval (FR); Pierre Joly, Massy (FR); Laurent Chauvier, Paris (FR); Guillaume De Saint Marc, Paris (FR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Middlesex (GB)

(21) Appl. No.: 11/992,568

(22) PCT Filed: Nov. 8, 2006
(86) PCT No.: PCT/GB2006/004170

§ 371 Date: May 14, 2008

Related U.S. Application Data
(60) Provisional application No. 60/736,242, filed on Nov. 14, 2005.

(51) Int. Cl. G06F 17/30

(52) U.S. Cl. 707/3; 707/E17.014

(57) ABSTRACT

A method for identifying additional content information to a content consumer, is disclosed. The additional content information relates to a content item selected for consumption by the content consumer. The method comprises: receiving data published by a content provider (203,205), wherein said data describes content information (207) available from said content provider; indexing said data thereby producing indexed data; storing said indexed data in a database (217); receiving a search request from a content consumer, said search request requesting said additional content information; searching said database (217) for data describing said additional content information; and identifying said additional content information by returning data identified during said searching to said content consumer.

### FIELD OF THE INVENTION

This invention relates to a method of and apparatus for identifying additional content information to a content consumer

### BACKGROUND OF THE INVENTION

An increasing amount of multimedia and audiovisual (AV) content is now available on the Internet. The amount is only likely to increase further with the development of a new generation of set top boxes (STBs) that are termed hybrid STBs, which in addition to having a broadcast capability (e.g. terrestrial TV, satellite TV, cable TV) also have a broadband internet capability (e.g. digital subscriber line (DSL) or cable) and are thus able to playback content from the internet.

U.S. Pat. No. 6,005,565 to Legall et al. describes a search tool that enables a user to search an electronic program guide (EPG) and the Internet with one search. The search tool performs the search and modifies the display of the EPG to identify programs identified by the search. A user can then view the EPG and select broadcasts of programs to display as well as proceed to the websites indicated by selecting corresponding elements on the display.

International Patent Application WO02/41542 of Nokia Corporation describes a digital television system that includes service provider equipment for transmitting a digital television broadcast; and a set-top box for decoding the digital television broadcast and displaying the decoded broadcast on an analogue television. A processor arranged in the set-top box includes an agent or program for: receiving information transmitted with the digital television broadcast; searching the internet for links based on the information; and displaying the list of links in response to a user input.

US published Patent Application US 2003/0226147 of Richmond et al. describes performing an Internet search based on a keyword obtained from an EPG.

The disclosures of all references mentioned above and throughout the present specification, as well as the disclosures of all references mentioned in those references, are hereby incorporated herein by reference.

### SUMMARY OF THE INVETION

The references mentioned previously have one thing in common—the search is performed on the Internet. The problem with searching the Internet is that the number of search results returned is often extremely large and not all of the results will link to content that is in a suitable format for display on a STB. Moreover, it is difficult to integrate Internet search results back into the existing EPG.

According to embodiments of the present invention, content providers establish agreements with TV operators, which provide for the consumption, by subscribers of the TV operator, of content published by the content providers. Such content is deliverable over a broadband internet network from the origin source to the subscriber's equipment (e.g. STB). The content providers publish data describing their content to a database operated by the TV operator which receives and indexes the data. Only content authorized by the TV operator for consumption by the TV operator's subscribers is published.

Based on a content item selected by the subscriber (content consumer) for consumption, the information comprised in the regular broadcast channels (e.g. metadata such as the Event Information Table (EIT) in a DVB-SI transport stream or TV Anytime data) can be extracted and used to perform a search for additional content information related to the selected content item. The search is performed in a dedicated server operated by the TV operator and linked to the database that comprises the data published by the content providers.

The search results returned to a subscriber's STB are not just HTML documents like the majority of those returned via standard internet search engines but rather links to additional content information, the details of which have been published by content providers and which are available to the subscriber over a broadband internet connection.

The additional content information is retrieved directly from the origin source, which is often hosted by the content provider and not the TV operator.

Sometimes the additional content information is retrieved automatically without any input from the subscriber. At other times, the additional content information is retrieved on-demand from a subscriber.

Sometimes, the additional content information is in a format suitable for display on the STB. At other times, the additional content information is transcoded before being transmitted to the STB.

Subscribers are also able to set the search criteria themselves and/or launch a new search based on criteria extracted from the selected content.

In this way, a subscriber is able to find additional content information related to a selected content item not only from the basic set of information comprised in regular broadcast channels but from a wider domain. The STB's broadband internet connection can be used to enrich a subscriber's viewing experience. Content items listed in an EPG can be linked to broadband internet content in such a way so as to add value to the user experience.

The additional content information related to events broadcast by a TV operator can be provided to subscribers without having an impact on the regular metadata broadcast by the TV operator and therefore without affecting the TV operator's broadcasting infrastructure. The EPG provided by a TV operator, the metadata used to construct the EPG and the method of transmitting the EPG to subscribers all remain the same.

According to a first aspect of the present invention there is provided a method for identifying additional content information to a content consumer, said additional content information relating to a content item selected for consumption by said content consumer, said method comprising:
receiving data published by a content provider, wherein said data describes content information available from said content provider;
indexing said data thereby producing indexed data;
storing said indexed data in a database;
receiving a search request from a content consumer, said search request requesting said additional content information;
searching said database for data describing said additional content information; and
identifying said additional content information by returning data identified during said searching to said content consumer.

Preferably, said data published by a content provider is published on a Really Simple Syndication channel.

Preferably, said search request comprises a hypertext transfer protocol request.

According to a second aspect of the present invention, there is provided an apparatus for identifying additional content information to a content consumer, said additional content information relating to a content item selected for consumption by said content consumer, said apparatus comprising:
data receiving means arranged in operation to receive data published by a content provider, wherein said data describes content information available from said content provider;
data indexing means arranged in operation to index said data;
storage means arranged in operation to store indexed data indexed by said data indexing means;
search request receiving means arranged in operation to receive a search request from a content consumer, said search request requesting said additional content information;
searching means arranged in operation to search said storage means for data describing said additional content information; and
transmission means arranged in operation to return data identified during said searching to said content consumer thereby identifying said additional content information to said content consumer.

According to a third aspect of the present invention, there is provided an apparatus for identifying additional content information to a content consumer, said additional content information relating to a content item selected for consumption by said content consumer, said apparatus comprising:
a data receiver arranged in operation to receive data published by a content provider, wherein said data describes content information available from said content provider;
a data indexer arranged in operation to index said data;
a database arranged in operation to store indexed data indexed by said data indexing means;
a search request receiver arranged in operation to receive a search request from a content consumer, said search request requesting said additional content information;
a search tool arranged in operation to search said database for data describing said additional content information;
a transmission device arranged in operation to return data identified during said searching to said content consumer thereby identifying said additional content information to said content consumer.

According to a fourth aspect of the present invention, there is provided a method for identifying additional content information to a content consumer, said method comprising:
receiving an input from a content consumer, said input identifying a content item selected for consumption by a content consumer;
sending a search request to a search tool, said search request requesting additional content information related to the content item selected by said content consumer, said search tool comprising an indexed storage device storing indexed data published by content providers, said data describing content information available from said content provider;
receiving search results from said search tool, said search results comprising data describing additional content information related to the content item selected by said content consumer; and
identifying said additional content information to said content consumer using said received data.

Preferably, said search request is constructed from data extracted from the transmission of said selected content item.

Preferably, said extracted data comprises data transmitted as part of an Event Information Table in a Digital Video Broadcasting Service Information transport stream.

Preferably, said search request is sent to said search tool automatically on receiving said input.

Preferably, said search request is sent to said search tool in response to further input from said content consumer.

Preferably, said further input identifies the criteria by which to carry out said search.

Preferably, said search request is sent over a bidirectional communications link.

Preferably, said search request is sent over a broadband internet communications link.

Preferably, said data describing additional content information includes data defining the location from where said additional content information can be obtained.

Preferably, said location comprises a location within an internet and said data defining said location comprises a uniform resource locator.

Preferably, said method further comprises:
receiving further input from content consumer, said further input identifying additional content information for consumption by said content consumer;
sending an information request to a content server, said information request requesting said additional content information;
receiving said additional content information; and
displaying said additional content information to said content consumer.

Preferably, said additional content information is transcoded before being received.

Preferably, said method further comprises:
sending a further search request to said search tool, said further search request requesting further additional content information related to the additional content information identified by said content consumer;
receiving further search results from said search tool, said further search results comprising data describing further additional content information related to the additional content information identified by said content consumer; and
identifying said further additional content information to said content consumer using said received data.

According to a fifth aspect of the present invention, there is provided an apparatus for identifying additional content information to a content consumer, comprising:
input receiving means arranged in operation to receive an input from a content consumer, said input identifying a content item selected for consumption by a content consumer;
search request transmission means arranged in operation to send a search request to a search tool, said search request requesting additional content information related to the content item selected by said content consumer, said search tool comprising an indexed storage device storing indexed data published by content providers, said indexed data describing content information available from said content provider;
search request receiving means arranged in operation to receive search results from said search tool, said search results comprising data describing additional content information related to the content item selected by said content consumer; and
display means arranged in operation to identify said additional content information to said content consumer using said received data.

According to a sixth aspect of the present invention. there is provided apparatus for identifying additional content information to a content consumer, comprising:
an input receiver arranged in operation to receive an input from a content consumer, said input identifying a content item selected for consumption by a content consumer;
a search request transmitter arranged in operation to send a search request to a search tool, said search request requesting additional content information related to the content item selected by said content consumer, said search tool comprising an indexed storage device storing indexed data published by content providers, said indexed data describing content information available from said content provider;
a search request receiver arranged in operation to receive search results from said search tool, said search results comprising data describing additional content information related to the content item selected by said content consumer; and
a content identifier arranged in operation to identify said additional content information to said content consumer using said received data.

### BRIEF DESCRIPTION OF THE DRAWINGS

Embodiments of the present invention will now be described, by way of example only, with reference to the accompanying drawings, wherein like reference numbers refer to like parts, and in which:

FIG. 1 is an illustration of a digital television according to embodiments of the present invention;

FIG. 2 is a simplified block diagram of an additional content information search system according to embodiments of the present invention;

FIG. 3 is a more detailed block diagram of the xSearch tool of FIG. 2;

FIG. 4 is an information flow diagram of an exemplary search carried out in the search system of FIG. 2;

FIG. 5 is an information flow diagram of an advanced search carried out in the search system of FIG. 2;

FIG. 6a is block diagram showing a system for delivering content to a STB in the system of FIG. 2 according to an embodiment of the present invention;

FIG. 6b is a block diagram showing a further system for delivering content to a STB in the system of FIG. 2 according to a further embodiment of the present invention;

FIGS. 7a to 7i are examples of screenshots displayed to a user using the system of FIG. 2.

### DETAILED DESCRIPTION OF PREFERRED EMBODIMENTS

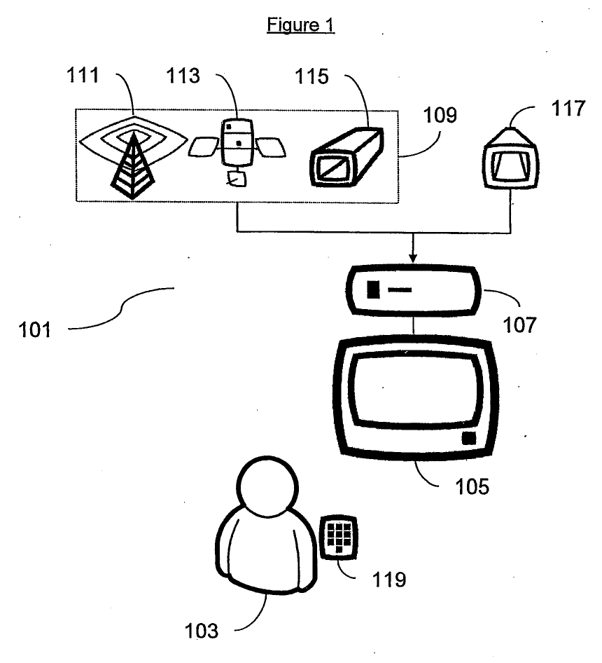

Referring to FIG. 1, there is provided a digital television environment 101, in which a user 103 can view digital television channels on a television 105. Television 105 is connected to a set top box (STB) 107 which has a broadband connection to the internet. Television channels are delivered to STB 107 via one or more of a plurality of broadcast source networks 109 (e.g. terrestrial TV broadcast network 111 and/or satellite TV broadcast network 113 and/or cable TV broadcast network 115) and/or a broadband internet source 117 (e.g. Internet Protocol Television (IPTV) network).

Editorial information describes the television programmes (content/events) showing on the television channels. In preferred embodiments, the editorial information comprises data contained within and extracted from an Event Information Table (EIT) defined in the Digital Video Broadcasting Service Information (DVB-SI) standard (“Digital Video Broadcasting (DVB); Specification for Service Information (SI) in DVB systems”, ETSI EN 300 468) and transmitted as part of the DVB transport stream. The EIT can be used to give information such as the programme title, start time, duration, a description (synopsis) and parental rating. It is also possible to classify programmes using “content descriptors”, which are drawn from a two-level genre list (the top level consisting of ten broad programme categories—movie/drama, news/current affairs, show/game show etc.—within each of which there are between seven and eighteen sub-categories). It is also possible to classify programmes using “private descriptors”, which a particular TV operator can tailor to their individual needs. For example, if a TV operator wanted to add a “press rating” descriptor to each movie delivered, the TV operator would define a “press rating” private descriptor.

Editorial information is available to user 103 either via an electronic programme guide (EPG) (an on-screen guide to scheduled television programs (content), allowing a viewer to navigate, select and discover content by e.g. time, title, channel number, etc.) or a zap banner (an on-screen banner display comprising e.g. channel number, channel name, date, time, title etc.). User 103 can cause an EPG or zap banner to be displayed on television 105, and navigate through an EPG or zap banner, using a remote control 119.

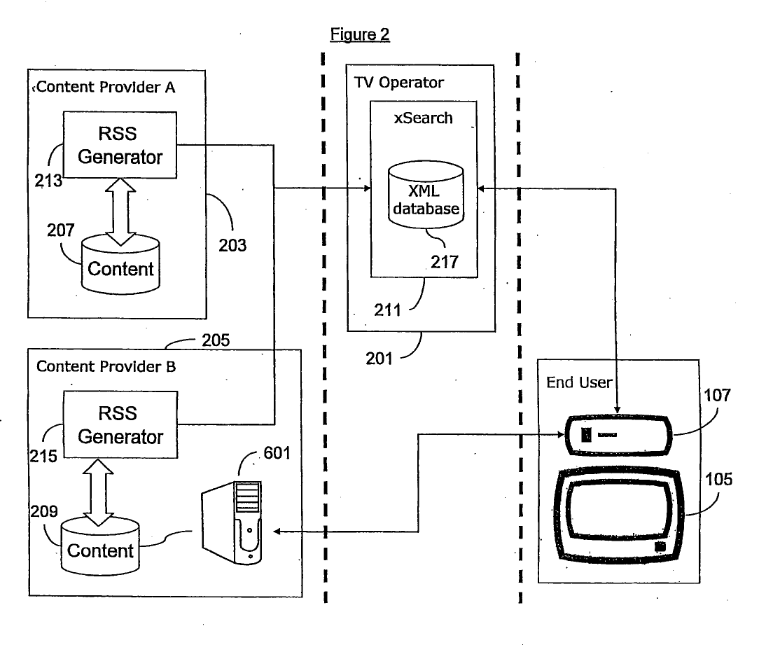

Referring now to FIG. 2, a TV operator 201 has pre-negotiated agreements (sometimes referred to as ‘service level agreements’ (SLA)) with content provider A 203 and content provider B 205, whereby content provider A 203 and content provider B 205 can offer additional content 207/209 for delivery to and consumption by end user 103. Content provider A 203 and content provider B 205 publish details of the additional content by sending information to the xSearch indexing and search engine 211 controlled by TV operator 201, a description of which will be provided later. In the present embodiment, content provider A 203 and content provider B 205 publish information on Really Simple Syndication (RSS) 2.0 channels (RSS 2.0 Specification, www.rssboard.org) and extensions thereto. The following is a non-limiting list of extensions preferably forming a part of the RSS channels:
(a) picture gallery (a gallery of pictures associated with the content item and the internet address where the pictures are available from);
(b) trailer (a video summary of the content item together with the internet address where the trailer is available from);
(c) ratings (e.g. given by members of the press and/or other viewers in relation to the content item);
(d) recommendations (e.g. values being the names of newspapers, magazines, web sites etc.);
(e) credits (roles such as actor, director, artist, author etc.);
(f) category (mapping to the above mentioned DVB content descriptor);
(g) localization by elements (e.g. synopsis in English or French, media poster in English or French; title in English or French; etc.
(h) technical information (e.g. digital rights management (DRM) source information, encryption parameters, etc.)
(i) target content address (e.g. if the initial content is not suitable for the STB 107 and has been (or will be) transcoded, the internet address where the transcoded content is available from).

It should be noted that these extensions will vary between content items. For example, a “picture gallery” may not be available for every movie or may not apply to some content items, e.g. a news summary. Content provider 203 comprises RSS generator 213 and content provider B 205 comprises RSS generator 215 for publishing editorial information using RSS. More details of the publication process will be provided later.

xSearch indexing and search engine 211 performs a full indexing of the editorial information published by content provider A 203 and content provider B 205 and stores the indexed results in an associated XML database 217.

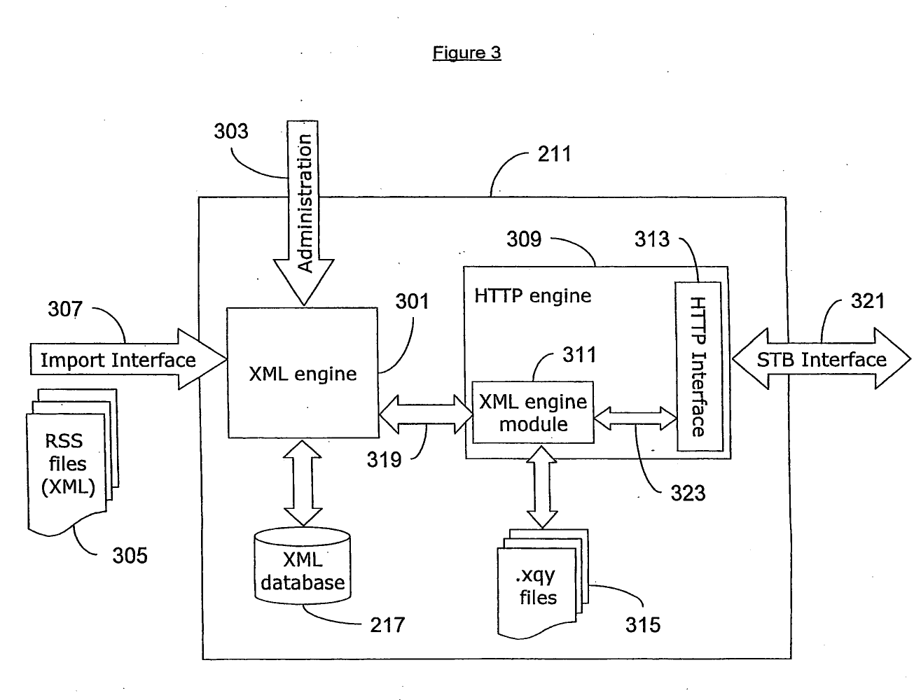

Referring now to FIG. 3, in preferred embodiments, xSearch 211 comprises an XML engine 301 (e.g. the Sedna XML database management system, http://modis.ispras.ru/sedna). Using administration interface 303, an administrator can create XML database 217 and create a collection in XML database 217. Collection is a mechanism of gathering and organising multiple documents (e.g. multiple XML RSS files from multiple content providers) into a single logical entity and is described at http://www.w3.org/TR/xquery-opertors/#func-collection. Collection also provides a uniform way of writing xQuery and XML (update) statements addressed to multiple documents at once. XML engine 301 imports XML RSS files 305 into XML database 217 via an import interface 307.

xSearch 211 further comprises HTTP engine 309 (e.g. the Apache HTTP Server, http:/httpd.apache.org). HTTP engine 309 itself comprises XML engine 311 and HTTP interface 313.

XML engine module 311 (e.g. Sedna module for Apache HTTP Server (mod_sedna 1.3) http://modis.ispras.ru/FTPContent/mod_sedna-1.3.tar.gz) receives XML query (xQuery, http://www.w3.org/TR/xquery) requests from HTTP interface 313, retrieves the appropriate xQuery handler script (.xqy file) from a store of .xqy files 315 and sends the xQuery to XML engine x01 via interface 319. XML engine module 311 also receives xQuery results back from XML engine 301.

HTTP interface 313 receives HTTP requests sent from STB 107 over interface 321 and sends xQuery requests to XML engine module x11 via interface 323. HTTP interface 313 also receives xQuery results from XML engine module 311 and sends the results back to STB 105 as an HTTP response.

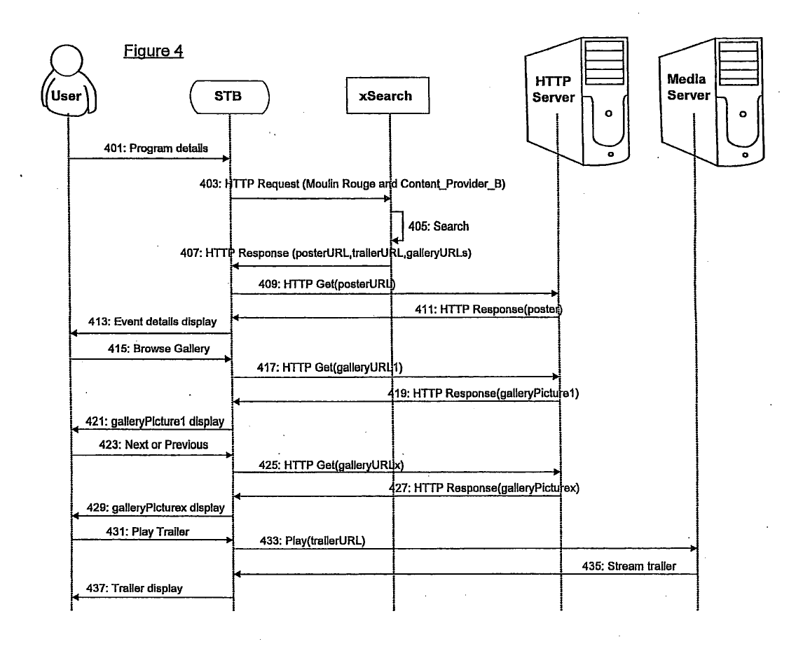

In response to actions by user 103, an application within STB 107 performs a search of database 217 using xSearch 211. This process will now be described with reference to FIG. 4.

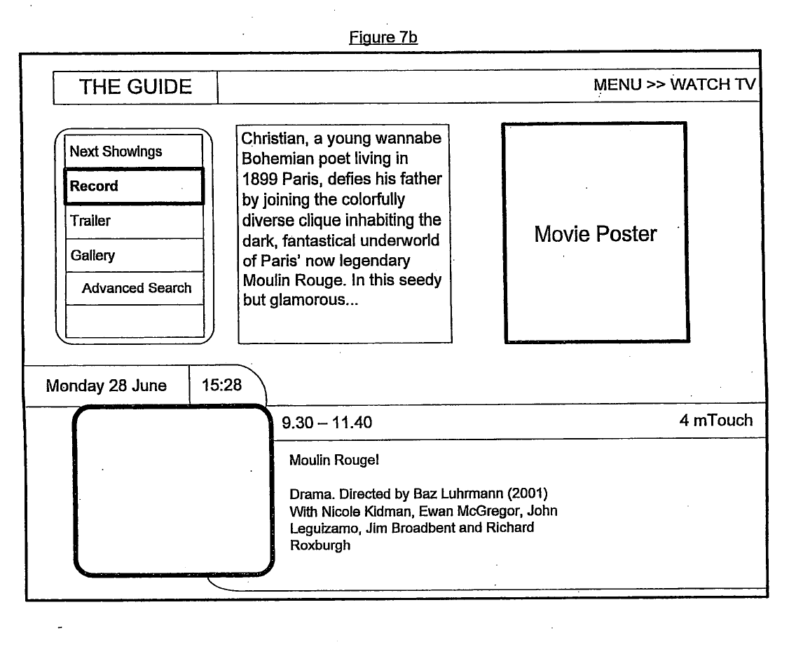

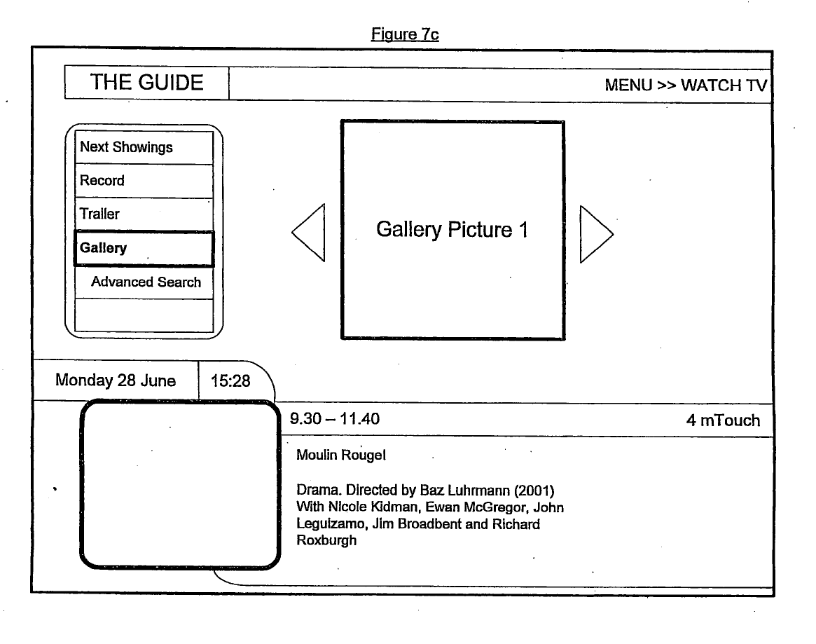

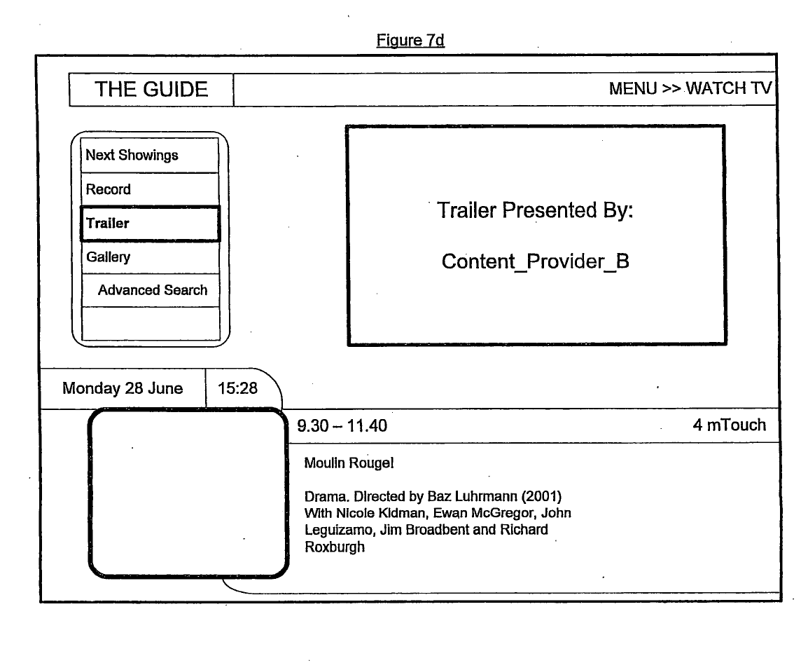

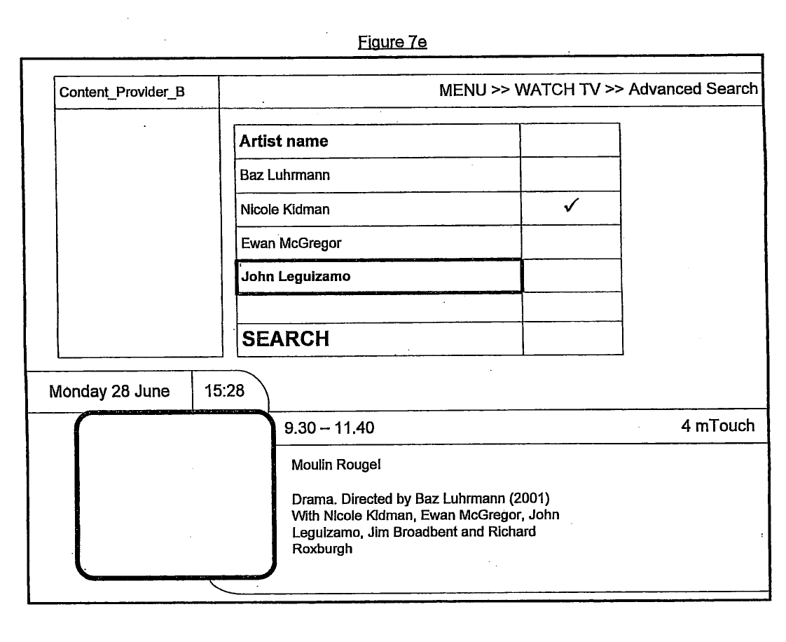

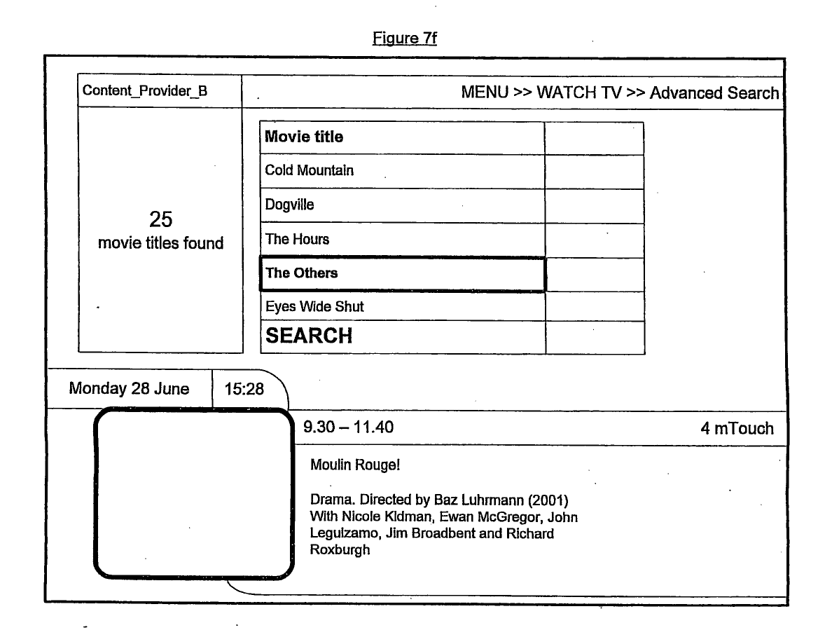

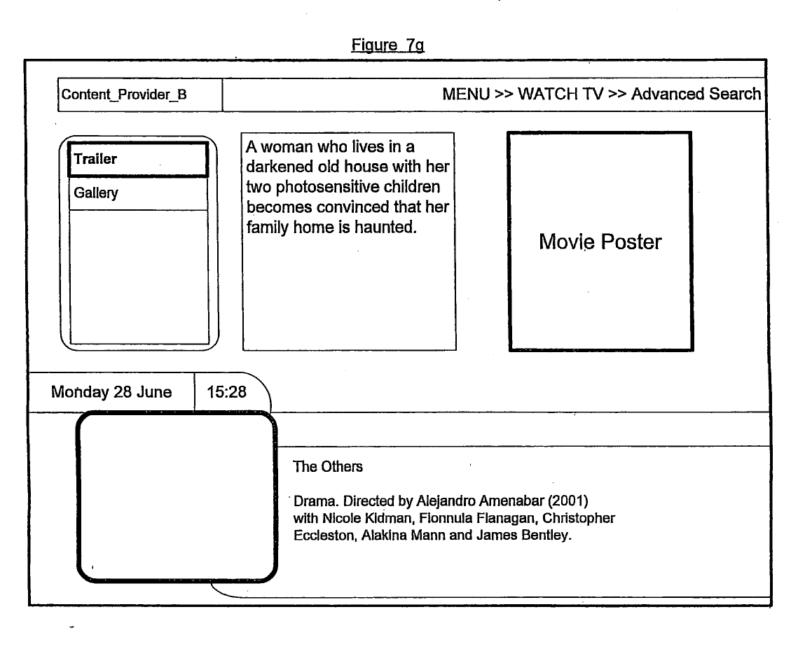

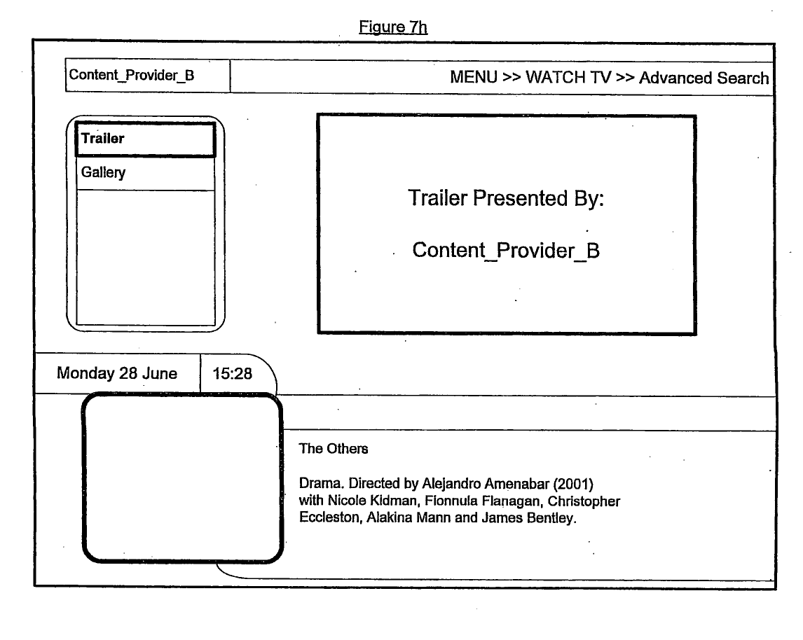

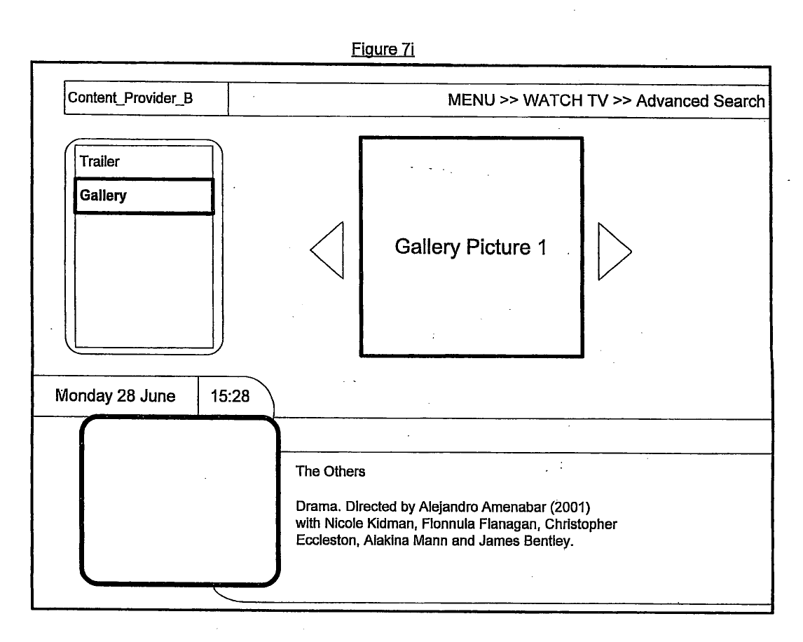

In a conventional digital TV environment, when a user identifies/selects an item of content using an EPG grid or a zap banner, the user can access more detailed information about the content item but this is limited to the information provided by the service information (SI), and more specifically, the information provided in the EIT. This is normally limited to textual information. This is illustrated in the screen shot of FIG. 7a which shows an EPG with the movie ‘Moulin Rouge!’ highlighted/selected. The detailed information in the bottom half of the screen is limited to the start/finish time (09:30-11:40), channel (4 mTouch), title, genre (Drama), year (2001) and some credits (including the director and some lead actors).

The search system of the present invention offers user 103 a content search facility which enriches the viewing experience of user 103 by making available to user 103 additional content from the internet that is related to an item of content selected by user 103. In preferred embodiments of the present invention, when user 103 identifies and selects an item of content (step 401), an application within STB 107 accesses the information provided in the EIT relating to the selected content item.

There are several ways to access the information provided in the EIT, including (but not limited to):
(a) Basic DVB table (EIT) (with or without additional private descriptor(s)/private table(s)) filtering process in real time;
(b) Extraction from a cache stored in a storage area (e.g. memory, hard disk) on STB 107. The cache is updated at regular intervals by software on STB 107 (either by a download from a broadcast source (e.g. a Carousel—a mechanism that allows data to be pushed from a broadcaster to multiple receivers by transmitting a data set repeatedly in a standard format) or by download from a remote server via a broadband connection);
(c) Online request to a remote server on which the information is stored (via the broadband connection).

The STB application then uses the information contained within the EIT to create a search request which it sends to xSearch 211 (step 403). In the present embodiment, xSearch 211 is identified by an Internet Protocol (IP) address/port number pair.

The search request is created as detailed below:
(i) One or more field/value pairs are extracted from metadata broadcast together with content (e.g. EIT). For example, Directors and actors may be provided in the metadata in the form “From Director A, with Actor A and Actor B”. In such a case the following field/value pairs might be extracted: director=Director A; actor=Actor A; actor=Actor B;
(ii) Each field/value pair is translated into a search criteria/value pair so that it complies with the URL request format specifications of xSearch. For example, the field/value pairs described above might be translated into the following search criteria/value pairs: search_dir=Director A; search_act=Actor A; search_act=Actor B; and
(iii) Each criteria/value pair is concatenated in order to perform a Boolean OR or AND operation between each pair. For example, the search criteria/value pais may be concatenated as follows: “search_dir=Director A AND (search_act=Actor A OR search_act=Actor B)”.

In alternative embodiments, an optional step may be inserted between step (ii) and step (iii). One or more specific criteria/value pair(s) may be added by the STB application and not retrieved from the broadcast metadata in order to apply the search to a particular XML collection. This is useful in order to apply the search to a particular content provider and may be achieved by embedding a static value in the STB software; or by a value retrieved from broadcast metadata that is to be used as a configuration parameter when using the STB application; or by an online request to a server under the TV operator's control in order to retrieve the configuration parameter when the STB application is launched; or retrieving the STB configuration when booting the STB (e.g. during the DHCP configuration.

In the present embodiment, the search request comprises “title=Moulin Rouge! AND channel_title=Content_Provider_B” and is sent from STB 107 to xSearch 211 as an HTTP POST request.

Upon receipt of the search request, xSearch 211 extracts the search criteria and performs a query based on the extracted criteria/value pair (i.e. xSearch 211 searches database 217 (step 405)). Then xSearch 211 returns the results of the search as an HTTP RESPONSE to STB 107 (step 407). The results comprise additional content information related to the item selected by user 103 and may include, for example:
Content title;
Content provider name/location;
Content genre/type/category;
Year of publication of content;
Content description (e.g. movie synopsis);
Credits (roles) list related to the content item (e.g. actors, directors, presenters);
Recommendations/reviews/ratings (e.g. from newspapers, magazines);
URL for getting more information (e.g. HTML page dedicated to the content item);
URL for getting a still picture related to the content item (e.g. movie poster);
URL(s) for getting a one or more pictures from a picture gallery related to the content item (e.g. movie screen shots, actor portraits); and
URL for getting a video and/or audio clip related to the content item (e.g. movie trailer, sound bite).

Other information that can be returned to STB 107 will be apparent to someone skilled in the art.

In the present embodiment, the search results comprise:
URL for getting the movie poster of Moulin Rouge!;
URL for getting the movie trailer of Moulin Rouge!; and
URLs for getting a series of still gallery pictures from Moulin Rouge!.

The application on STB 107 receives the search response. In the present embodiment, STB 107 may then automatically retrieve the movie poster of the movie Moulin Rouge! by sending an HTTP GET request to the relevant HTTP server identified by its URL in the search results (step 409). The HTTP server responds by returning the movie poster as an HTTP RESPONSE (step 411). The STB 107 then displays details of the item of content selected by user 103 (step 413), together with the movie poster. The details of the content item include information extracted from the EIT together with a list of options to get further information related to the selected content, the list being tailored according to the results returned by xSearch 211.

Referring to the screen shot in FIG. 7b, in the present embodiment, the details of the content item include synopsis, start/finish time, channel, title, genre, year and some credits. The movie poster is displayed on the right hand side of the screen. The options available to user 103 are presented on the left of the screen and include viewing when Moulin Rouge! is next scheduled to be shown (“Next Showings”), recording the content item (“Record”), viewing the movie trailer of Moulin Rouge! (“Trailer”) and viewing the gallery pictures from Moulin Rouge! (“Gallery”).

User 103 then decides to browse the gallery pictures and selects this option (e.g. using remote control 119 to highlight the “Gallery” option and pressing a button on remote control 119 to select the “Gallery” option) (step 415). This is illustrated in the screen shot of FIG. 7c where the “Gallery” option is highlighted. In response, STB 107 retrieves the first gallery picture by sending an HTTP GET request to the relevant HTTP server identified by its URL in the search results (step 417). The HTTP server responds by returning the gallery picture as an HTTP RESPONSE (step 419) and the gallery picture is displayed to user 103 (step 421). In the present embodiment, this is done by opening an HTML browser window to the URL specified in the search results. Referring to the screen shot in FIG. 7c, user 103 sees the first gallery picture in an HTML browser window. (In alternative embodiments, the gallery picture is retrieved using HTTP but displayed within a Java application.

User 103 then selects another picture from the gallery (e.g. using remote control 119 to select the ‘next’ or ‘previous’ picture in the series of gallery pictures by (step 423)—in the screenshot of FIG. 7b, this is illustrated by left and right pointing arrows either side of the gallery picture). In response, STB 107 retrieves the gallery picture by sending an HTTP GET request to the relevant HTTP server identified by the URL in the search results (step 425). The HTTP server responds by returning the gallery picture as an HTTP RESPONSE (step 427) and the gallery picture is displayed to user 103 (step 429). As described above, in the present embodiment this is done by opening an HTML browser window to the URL specified in the search results. (In alternative embodiments, the gallery picture is retrieved using HTTP but displayed within a Java application.)

User 103 then decides to view the movie trailer and selects this option (e.g. using remote control 119 to highlight the “Trailer” option and pressing a button on remote control 119 to select the “Trailer” option) (step 431). This is illustrated in the screen shot of FIG. 7d by the “Trailer” option being highlighted. In response, a media player application embedded in STB 107 sends a request to play the trailer to the media server identified by the URL in the search results (step 433). The media server responds by streaming the movie trailer to STB 107 (step 435) which displays the trailer to user 103 (step 437). Referring to the screen shot in FIG. 7d, user 103 sees the trailer in media application player window.

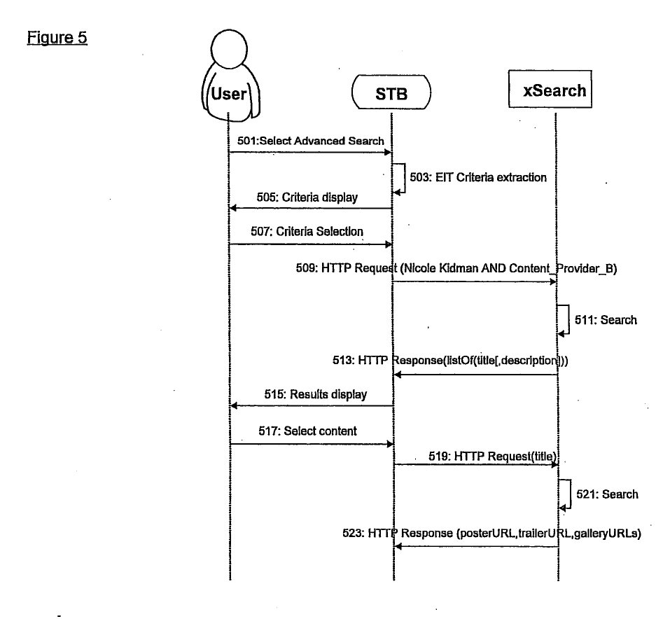

It will be remembered that the STB 107 displayed details of the item of content selected by user 103, which included information extracted from the EIT together with a list of options to get further information related to the selected content, the list being tailored according to the results returned by xSearch 211. In the present embodiment, user 103 is also presented with a further option of an “Advanced Search” (as shown in the screenshot of FIG. 7b) and this option is now described with reference to FIG. 5. When user 103 selects the “Advanced Search” option for a particular item of content (step 501), the STB application uses the information relating to the selected item and contained within the EIT to identify firstly field/value pairs and then criteria/value pairs for the search request (step 503). For example, if the EIT event descriptor or extended event descriptor contains a text string such as “From DirectorA with Actor1, Actor2, Actor3”, the text string may be analysed by the STB and the field/value pairs “Director A”, “Actor 1”, “Actor 2”, “Actor 3” may be extracted. The criteria/value are then generated and displayed to user 103 (step 505).

In the present embodiment, shown in the screenshot of FIG. 7e, the criteria selected is “artist name” and the various possible values are the names of artists that have been extracted from the EIT related to the selected item of content (Moulin Rouge!), as described above.

User 103 then selects the criteria/value pairs to be used for the search request (step 507) and submits the search to xSearch 211. In the present embodiment, user 103 decides to search for all other content featuring the actor ‘Nicole Kidman’, uses remote control 119 to place an on-screen marker next to her name, as illustrated in the screenshot of FIG. 7e, and submits the search (e.g. by pressing a button on remote control 119).

A first query is then performed in xSearch 211 to retrieve a list of content based on criteria selected by user 103 (step 509). In the present embodiment, the search request comprises “actor=Nicole Kidman AND channel_title=Content_Provider_B” and is sent from STB 107 to xSearch 211 as an HTTP POST or GET request.

Upon receipt of the search request, xSearch 211 extracts the search criteria and performs a query based on the extracted criteria/value pair (i.e. xSearch 211 searches database 217 (step 511)). Then xSearch 211 returns the results of the search as an HTTP RESPONSE to STB 107 (step 513). The results comprise a list of content items according to their title and may optionally comprise some additional details relating to each content item. In the present embodiment, the additional details comprise: synopsis, title, genre, year and some credits. The results are displayed to user 103 (step 515) and this is illustrated in the screenshot of FIG. 7f, where a list of content items is shown in the middle of the screen.

User 103 is then able to select an item of content from the results list (e.g. using remote control 119 to highlight a particular content item (e.g. “The Others”) and pressing a button on remote control 119 to select that content item).

When the user has selected an item (step 517) in the list of results returned by xSearch 211, a second search request is sent to xSearch 211 (step 519) to get further information about the selected item. In the present embodiment, the search request comprises “title=The Others” and is sent from STB 107 to xSearch 211 as an HTTP POST request.

Upon receipt of the search request, xSearch 211 extracts the search criteria and performs a query based on the extracted criteria/value pair (i.e. xSearch 211 searches database 217 (step 521)). Then xSearch 211 returns the results of the search as an HTTP RESPONSE to STB 107 (step 523). The results comprise additional content/information related to the item selected by user 103 and may include, for example:
Content title;
Content provider name/location;
Content genre/type/category;
Year of publication of content;
Content description (e.g. movie synopsis);
Credits (roles) list related to the content item (e.g. actors, directors, presenters);
Recommendations/reviews/ratings (e.g. from newspapers, magazines);
URL for getting more information (e.g. HTML page dedicated to the content item);
URL for getting a still picture related to the content item (e.g. movie poster);
URL(s) for getting a one or more pictures from a picture gallery related to the content item (e.g. movie screen shots, actor portraits); and
URL for getting an video and/or audio clip related to the content item (e.g. movie trailer, sound bite).

Other information that can be returned to STB 107 will be apparent to someone skilled in the art.

In the present embodiment, the search results comprise:
URL for getting the movie poster of The Others;
URL for getting the movie trailer of The Others; and
URLs for getting a series of still gallery pictures from The Others.

The application on STB 107 receives the search response. In the present embodiment, STB 107 then automatically retrieves the movie poster of the movie The Others by sending an HTTP GET request to the relevant HTTP server identified by its URL in the search results, as described above in relation to step 409, FIG. 4. The HTTP server responds by returning the movie poster as an HTTP RESPONSE, as described above in relation to step 411, FIG. 4.

The STB 107 then displays details of the item of content selected by user 103 (including synopsis, title, genre, year and some credits) together with the movie poster and a list of options to get further information related to the selected content, the list being tailored according to the results returned by xSearch 211.

Referring to the screen shot in FIG. 7g, in the present embodiment, the details of the content item include synopsis, start/finish time, channel, title, genre, year and some credits). The movie poster is displayed on the right hand side of the screen. The options available to user 103 are presented on the left of the screen and include viewing the movie trailer of Moulin Rouge (“Trailer”) and viewing the gallery pictures from Moulin Rouge (“Gallery”). User 103 can then view the movie trailer (FIG. 7h) and/or the gallery pictures (FIG. 7i) as described above in relation to steps 415-437, FIG. 4.

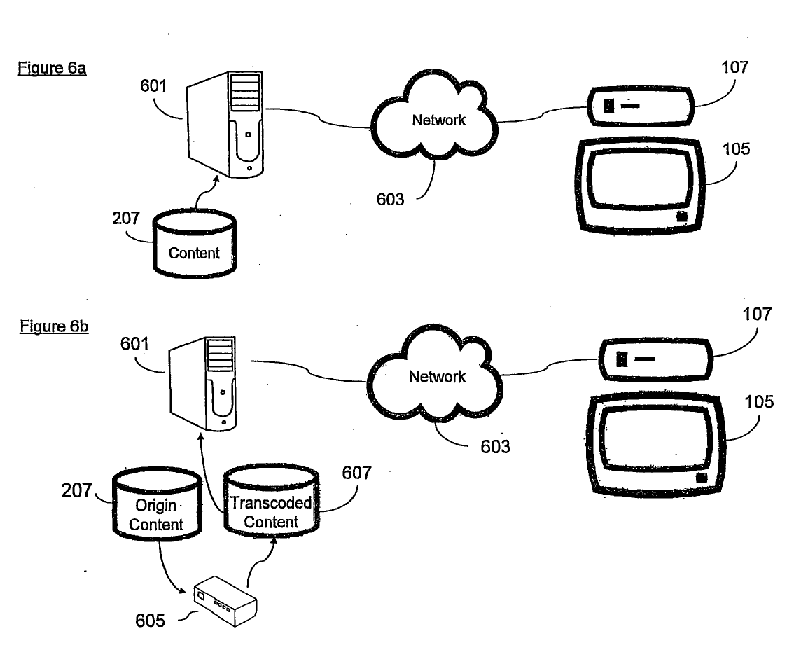

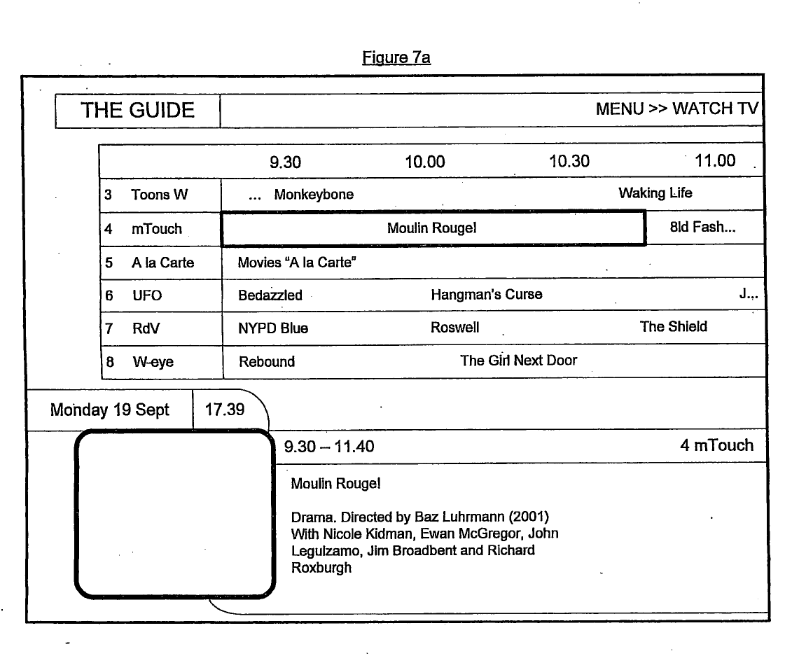

It will be appreciated by those skilled in the art how to display/play media content, sourced from a content provider over the internet, on STB 107. In some embodiments, the internet media content will be delivered by the media server in a format supported by STB 107 (e.g. MPEG-2 Transport Stream (TS), published as the ISO/IEC 13818 international standard), as shown in FIG. 6a where content is delivered from database 207 to media server 601 and then directly to STB 107 via network 603.

Sometimes, however, the internet media content is not available in a format suitable for STB 107 (e.g. the content may only be available in Windows Media Player format which is not suitable for STB 107). In such a case, the media content is transcoded before being delivered to STB 107. Transcoding of internet media content is described at www.hpl.hp.com/personal/Sung-Ju_Lee/abstracts/papers/tom2004.pdf. Referring to FIG. 6b, origin content is transferred from database 207 to a transcoding tool 605 (e.g. “VLC media player” available from VideoLAN, Club VIA Centrale Reseaux, Residence Ecole Centrale, 2 Avenue Sully Prudhomme, 92 290 Chatenay Malabry, France) from where it is transferred to transcoded content database 607 before being loaded onto media server 601. Alternatively, a transcoding proxy within network 603 (not shown) is used to deliver content in a format suitable for STB 107, which is configured with a proxy client for use when playing such content.

It will be apparent from the foregoing description that many modifications or variations may be made to the above described embodiments without departing from the invention. Such modifications and variations include:

In the above described embodiments, the editorial information comprised data contained within and extracted from an Event Information Table (EIT) defined in the Digital Video Broadcasting Service Information (DVB-SI) standard and transmitted as part of the DVB transport stream. In alternative embodiments, the editorial information may comprise other forms of metadata broadcast by a TV operator (e.g. TV Anytime data as described and defined in specifications of the European Telecommunications Standard Institute (ETSI) published as ETSI TS 102 822 and ETSI 102 323; or Broadband Content Guide (BCG) data (e.g. an HTML or flash catalogue). Other forms of metadata that can be used to describe editorial information will be apparent to someone skilled in the art.

In the above described embodiments, content providers published data describing their content on Really Simple Syndication (RSS) 2.0 channels (RSS 2.0 Specification, www.rssboard.org) and extensions thereto. In alternative embodiments, content providers may publish information using the Atom Syndication Format and Atom Publishing Protocol (described in request for Comment (RFC) 4287 of the Internet Engineering Task Force (IETF)); or by transmitting XML or XML compliant files to a repository that stores XML or SML compliant files and to which xSearch has access. xSearch would then be configured to poll/check the repository to check (e.g. at regular intervals) for new information published by content providers. The content providers could also be configured to send a notification command to xSearch to notify xSearch of new information in the repository. In other embodiments, xSearch could be configured to use HTML page analysis in order to extract information from the Internet web sites of content providers. Other methods by which content providers can publish data describing their content to the xSearch database will be apparent to someone skilled in the art.

In the above described embodiments, user 103 identified/selected an item of content using an EPG grid or a zap banner and then could access more detailed information about the content item and other content/information linked to the selected item. In other embodiments, whilst user 103 was tuned to a channel (either broadcast or broadband internet) and watching an item of content, they could launch an interactive STB application (e.g. using a dedicated button on remote control 119 (e.g. the ‘red’ button) and select an option within the application for getting more detailed information and links to linked information. In yet other embodiments, upon launching the STB application, user 103 may automatically be provided with the more detailed information and links to linked information.

In some embodiments, TV operator 201 may restrict the list of content providers authorised to provide additional information in relation to broadcast events. For example, information about a particular movie may be restricted to a unique content provider. For other categories, additional information may be restricted to several content providers for a given list of channels (e.g. sports channels, news channels, etc.) In all embodiments, however, the same query mechanism is preferably used such that xSearch supports a plurality of content providers.

In some embodiments, STB 107 may have limited processing capability and therefore sets a limit on the number of search results that xSearch should return. STB 107 is also configurable to request that xSearch only return search results in a particular language.

In the above described embodiments, xSearch was identified by an Internet Protocol (IP) address/port number pair. In other embodiments, xSearch may be identified via a hostname (e.g. a domain name, URL, etc.). Other ways of identifying xSearch on the Internet will be apparent to someone skilled in the art.

In the above described embodiments, the STB sent the search request to xSearch using the Hypertext Transfer Protocol (HTTP). A suitable proprietary protocol could also be developed for sending the request. Other protocols for sending the search request from STB to xSearch will be apparent to someone skilled in the art.

In the above described embodiments, an application within STB received the search results from xSearch and displayed the elements of the results on TV 105. It will be appreciated by those skilled in the art that multiple windows may be required to display all the search results depending on the number of search results returned and the maximum number of search results that can be displayed in each window. In some embodiments, not all the search results are displayed at once and the application can be configured by TV operator 201 to decide which search results (or which elements of the search results) will be displayed at any given instant. Moreover, the location on the screen of the search results and which search results to display or not display can be decided by TV operator 201. When content is to be provided over the broadband internet by a content provider, TV operator may allow that content provider to customise the look and feel of the display displaying the search results so that information provided by the content provider can be distinguished from information provided by the TV operator.

In alternative embodiments, if no additional information related to a selected item of content is found (i.e. no search results are returned by xSearch), the STB application automatically proposes to user 103 to use the “Advanced Search” option. The list of criteria used in the first search request can be displayed to user 103 so that the user 103 can update the initial search request.

In the above described embodiments, an electronic program guide (EPG) was described. In alternative embodiments, user 103 may access an electronic content guide (ECG) that includes a mix of broadcast content and broadband internet content. Items of content from the broadband internet may not be provided with an EIT. The publication process used to populate the xSearch database is then used to provide data for the ECG with additional metadata used to enable the search facility. In yet further embodiments, user 103 could initiate a search from a content item that is not part of the regular TV channel line up (e.g. a video-on-demand (VOD) program item).

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined only by the claims which follow:

1-20. (canceled)

21. A method for identifying additional content to a content consumer, said additional content relating to a content item selected for consumption by said content consumer, said method comprising:
receiving data published by a content provider, wherein said data describes content available from said content provider;
indexing said data thereby producing indexed data;
storing said indexed data in a database;
receiving a search request from a content consumer, said search request requesting said additional content;
searching said database for data describing said additional content; and
identifying said additional content by returning data identified during said searching to said content consumer.

22. A method according to claim 21, wherein said data published by a content provider is published on a Really Simple Syndication channel.

23. A method according to claim 21, wherein said search request comprises a hypertext transfer protocol request.

24. Apparatus for identifying additional content to a content consumer, said additional content relating to a content item selected for consumption by said content consumer, said apparatus comprising:
data receiving means arranged in operation to receive data published by a content provider, wherein said data describes content available from said content provider;
data indexing means arranged in operation to index said data;
storage means arranged in operation to store indexed data indexed by said data indexing means;
search request receiving means arranged in operation to receive a search request from a content consumer, said search request requesting said additional content;
searching means arranged in operation to search said storage means for data describing said additional content; and
transmission means arranged in operation to return data identified during said searching to said content consumer thereby identifying said additional content to said content consumer.

25. Apparatus for identifying additional content to a content consumer, said additional content relating to a content item selected for consumption by said content consumer, said apparatus comprising:
a data receiver arranged in operation to receive data published by a content provider, wherein said data describes content available from said content provider;
a data indexer arranged in operation to index said data;
a database arranged in operation to store indexed data indexed by said data indexing means;
a search request receiver arranged in operation to receive a search request from a content consumer, said search request requesting said additional content;
a search tool arranged in operation to search said database for data describing said additional content;
a transmission device arranged in operation to return data identified during said searching to said content consumer thereby identifying said additional content to said content consumer.

26. A method for identifying additional content to a content consumer, said method comprising:
receiving an input from a content consumer, said input identifying a content item selected for consumption by a content consumer;
on receiving said input, automatically sending a search request to a search tool, said search request requesting additional content related to the content item selected by said content consumer, said search tool comprising an indexed storage device storing indexed data published by content providers, said data describing content available from said content provider;
receiving search results from said search tool, said search results comprising data describing additional content related to the content item selected by said content consumer; and
automatically presenting said additional content to said content consumer using said received data.

27. A method according to claim 26, wherein said search request is constructed from data extracted from the transmission of said selected content item.

28. A method according to claim 27, wherein said extracted data comprises data transmitted as part of an Event Information Table in a Digital Video Broadcasting Service Information transport stream.

29. A method according to claim 26, wherein said search request is sent to said search tool in response to further input from said content consumer.

30. A method according to claim 29, wherein said further input identifies the criteria by which to carry out said search.

31. A method according to claim 26, wherein said search request is sent over a bidirectional communications link.

32. A method according to claim 31, wherein said search request is sent over a broadband internet communications link.

33. A method according to claim 26, wherein said data describing additional content includes data defining the location from where said additional content can be obtained.

34. A method according to claim 33, wherein said location comprises a location within an internet and said data defining said location comprises a uniform resource locator.

35. A method according to claim 26, said method further comprising:
receiving further input from said content consumer, said further input identifying additional content for consumption by said content consumer;
sending a request to a content server, said request requesting said additional content;
receiving said additional content; and
displaying said additional content to said content consumer.

36. A method according to claim 26, wherein said additional content is transcoded before being received.

37. A method according to claim 26, said method further comprising:
sending a further search request to said search tool, said further search request requesting further additional content related to the additional content identified by said content consumer;
receiving further search results from said search tool, said further search results comprising data describing further additional content related to the additional content identified by said content consumer; and
identifying said further additional content to said content consumer using said received data.

38. Apparatus for identifying additional content to a content consumer, comprising:
input receiving means for receiving an input from a content consumer, said input identifying a content item selected for consumption by a content consumer;
search request transmission means for automatically sending a search request to a search tool in response to said input being received, said search request requesting additional content related to the content item selected by said content consumer, said search tool comprising an indexed storage device storing indexed data published by content providers, said indexed data describing content available from said content provider;
search request receiving means for receiving search results from said search tool, said search results comprising data describing additional content related to the content item selected by said content consumer; and
display means for automatically presenting said additional content to said content consumer using said received data.

39. Apparatus for identifying additional content to a content consumer, comprising:
an input receiver arranged in operation to receive an input from a content consumer, said input identifying a content item selected for consumption by a content consumer;
a search request transmitter arranged in operation to automatically send a search request to a search tool in response to said input being received, said search request requesting additional content related to the content item selected by said content consumer, said search tool comprising an indexed storage device storing indexed data published by content providers, said indexed data describing content available from said content provider;
a search request receiver arranged in operation to receive search results from said search tool, said search results comprising data describing additional content related to the content item selected by said content consumer; and
a content identifier arranged in operation to automatically present said additional content to said content consumer using said received data.
